(19) United States
(12) Patent Application Publication
(10) Pub. No.: US 2013/0134957 A1
(43) Pub. Date: May 30, 2013

(54) VOLTAGE GENERATION CIRCUIT

(71) Applicant: Takeshi Hioka, Yokohama-shi (JP)

(72) Inventor: Takeshi Hioka, Yokohama-shi (JP)

(73) Assignee: Kabushiki Kaisha Toshiba, Tokyo (JP)

(21) Appl. No.: 13/427,338

(22) Filed: Mar. 22, 2012

(30) Foreign Application Priority Data
Nov. 28, 2011 (JP) 2011-259550

(51) Int. Cl. G05F 3/02

(52) U.S. Cl. 323/311

(57) ABSTRACT

A voltage generation circuit according to one embodiment includes a first booster circuit configured to generate a first voltage having a first voltage value, and a second booster circuit group including a plurality of second booster circuits, each second booster circuit configured to generate a second voltage having a second voltage value. The second booster circuits switch to be connected in series and are configured to be capable of generating the first voltage together with the first booster circuit in a change from a first state to a second state.

### CROSS REFERENCE TO RELATED APPLICATION

This application is based upon and claims the benefit of priority from prior Japanese Patent Application No. 2011-259550, filed on Nov. 28, 2011, the entire contents of which are incorporated herein by reference.

### BACKGROUND

1. Field

The embodiments described herein relate to a voltage generation circuit.

2. Description of the Related Art

A semiconductor memory device such as the NAND flash memory includes a voltage generation circuit for generating various amounts of voltages depending on the types of operations. When the circuit operations for generating those voltages need several types of voltages, separate booster circuits provided for the respective voltages will increase the area of the voltage generation circuit on the semiconductor substrate.

### BRIEF DESCRIPTION OF THE DRAWINGS

FIG. 1 is a schematic configuration of a semiconductor memory device including a voltage generation circuit according to an embodiment;

FIG. 2 shows a configuration of a booster circuit of a voltage generation circuit according to an embodiment;

FIG. 3 shows the relationship between data stored in a memory cell and threshold voltages;

FIG. 4 illustrates voltages applied to a NAND cell unit in a write operation;

FIG. 5 illustrates voltages applied to a NAND cell unit in a read operation;

FIG. 6 illustrates voltages applied to a NAND cell unit in an erase operation;

FIG. 7 illustrates a configuration of a voltage generation circuit according to a first embodiment;

FIG. 8 is a timing diagram illustrating an example operation of a voltage generation circuit;

FIG. 9A illustrates an operation of a voltage generation circuit according to the first embodiment;

FIG. 9B illustrates an operation of a voltage generation circuit according to the first embodiment;

FIG. 10A illustrates an operation of a voltage generation circuit according to a second embodiment;

FIG. 10B illustrates an operation of a voltage generation circuit according to the second embodiment;

FIG. 11A illustrates an operation of a voltage generation circuit according to a third embodiment;

FIG. 11B illustrates an operation of a voltage generation circuit according to the third embodiment;

FIG. 12A illustrates an operation of a voltage generation circuit according to a fourth embodiment;

FIG. 12B illustrates an operation of a voltage generation circuit according to the fourth embodiment;

FIG. 13A illustrates an operation of a voltage generation circuit according to a fifth embodiment; and

FIG. 13B illustrates an operation of a voltage generation circuit according to the fifth embodiment.

### DETAILED DESCRIPTION

A voltage generation circuit according to one embodiment includes a first booster circuit configured to generate a first voltage having a first voltage value, and a second booster circuit group including a plurality of second booster circuits, each second booster circuit configured to generate a second voltage having a second voltage value. The second booster circuits switch to be connected in series and are configured to be capable of generating the first voltage together with the first booster circuit in a change from a first state to a second state.

Referring now to the drawings, the embodiments of the present invention will be described in more detail.

### First Embodiment

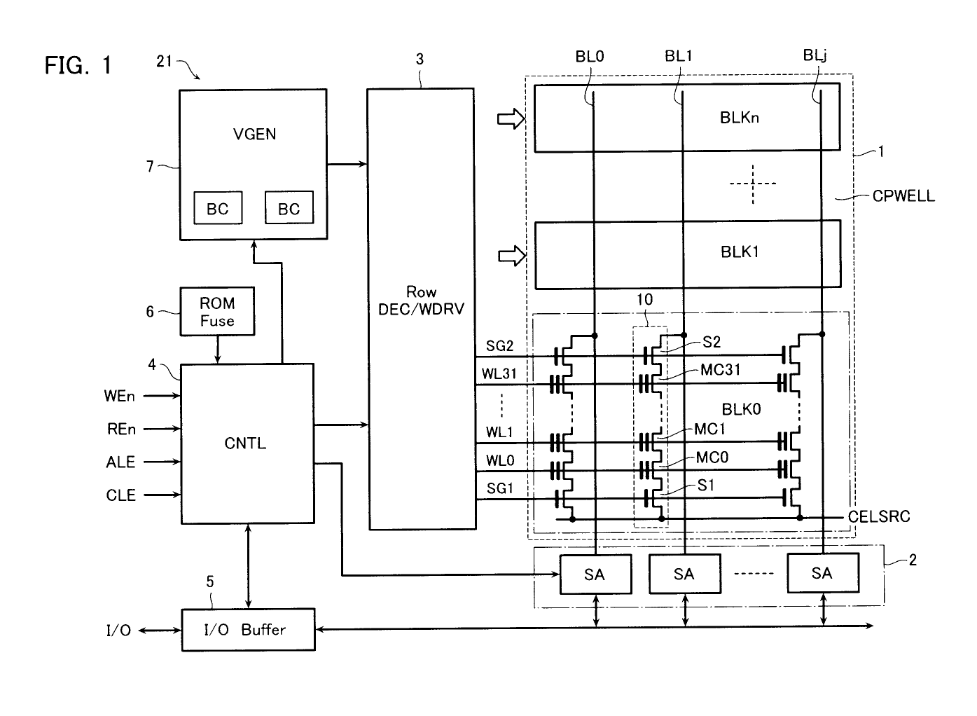

FIG. 1 shows a schematic configuration of a semiconductor memory device including a voltage generation circuit according to a first embodiment. The following description uses a NAND flash memory as an example of the semiconductor memory device. It will be appreciated, however, that voltage generation circuits according to the embodiments are not limited to the NAND flash memory, but are applicable to various semiconductor memory devices.

With reference to FIG. 1, a NAND flash memory 21 includes a memory cell array 1, a sense amplifier circuit 2, a row decoder 3, a controller 4, an input/output buffer 5, a ROM fuse 6, and a voltage generation circuit 7. The controller 4 forms a control portion for the memory cell array 1.

The memory cell array 1 includes NAND cell units 10 arranged in a matrix. One NAND cell unit 10 includes a plurality of memory cells MC (MC0, MC1, . . . , MC31) connected in series and select gate transistors S1 and S2 connected to the respective ends of the series. Although not shown, one memory cell MC may have a well-known stacked gate structure. The memory cell MC includes a drain, a source, a gate-insulating film (a tunnel insulating film) formed between the drain and source, a floating gate electrode as a charge accumulation layer formed on the gate-insulating film, an inter-gate insulating film formed on the floating gate electrode, and a control gate electrode formed on the inter-gate insulating film. The control gate electrodes of the memory cells MC in each NAND cell unit 10 are connected to respective different word lines WL (WL0, WL1, . . . , WL31).

The select gate transistor S1 has a source connected to a common source line CELSRC. The select gate transistor S2 has a drain connected to a bit line BL. The gate electrodes of the select gate transistors S1 and S2 are connected to respective select gate lines SG1 and SG2 in parallel with the word lines WL. A set of memory cells MC sharing one word line WL forms one page. When each memory cell MC stores multi-value data or even-numbered and odd-numbered bit lines are controlled alternately, a set of memory cells MC sharing one word line WL may form a plurality of pages of 2 or more pages.

With reference to FIG. 1, a set of NAND cell units 10 sharing the word lines WL and the select gate lines SG1 and SG2 form a block BLK as a unit of data erase. The memory cell array 1 includes a plurality of blocks BLK (BLK0, BLK1, . . . , BLKn) in the bit line BL direction. The memory cell array 1 including these blocks is formed in one cell well (CPWELL) on the silicon substrate.

The bit lines BL in the memory cell array 1 are connected to the sense amplifier circuit 2 including a plurality of sense amplifiers SA. The sense amplifiers SA form a page buffer for sensing read data and holding write data. The sense amplifier circuit 2 includes a column selection gate. The row decoder 3 (including a word line driver WDRV) selectively drives the word lines WL and the select gate lines SG1 and SG2.

The data input/output buffer 5 supplies and receives data as well as receives command data and address data between the sense amplifier circuit 2 and an external input/output terminal. The controller 4 receives external control signals such as a write enable signal WEn, a read enable signal REn, an address latch enable signal ALE, and a command latch enable signal CLE to generally control the memory operation.

Specifically, the controller 4 includes a command interface and an address hold/transfer circuit, and determines whether supplied data is write data or address data. According to this determination, write data is transferred to the sense amplifier circuit 2, and address data is transferred to the row decoder 3 and the sense amplifier circuit 2. Further, in response to the external control signals, the controller 4 controls the sequence of the read, write, or erase operation, and controls applied voltages or the like.

The voltage generation circuit 7 generates certain pulse voltages according to the control signals from the controller 4. The voltage generation circuit 7 generates various voltages necessary for the write operation, erase operation, and read operation.

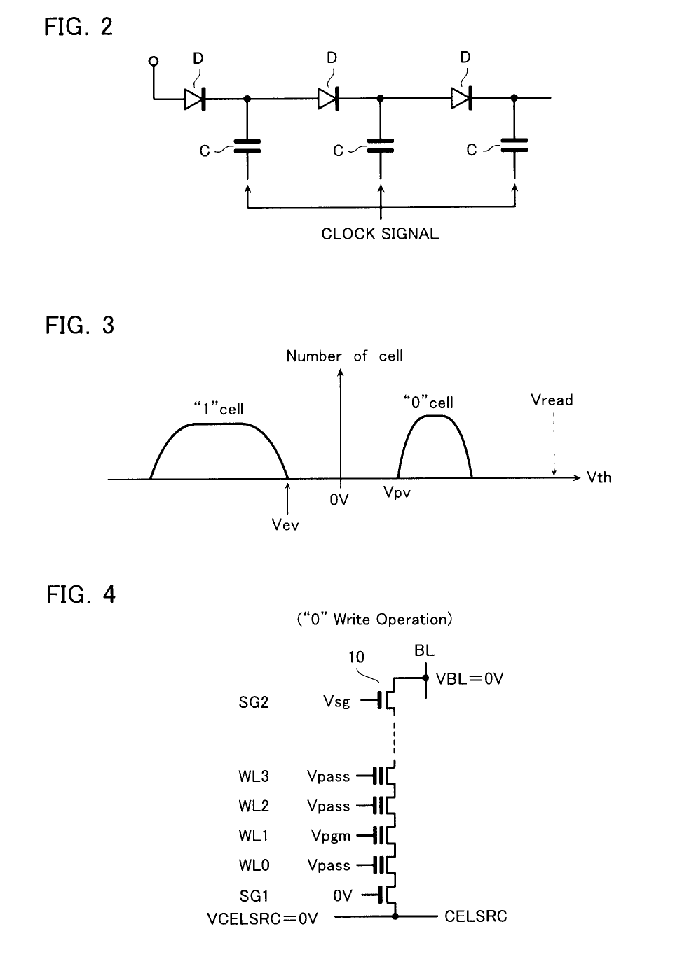

Here, the voltage generation circuit 7 includes a plurality of booster circuits BC for generating voltages. A charge pump provided in the booster circuit BC is operated to generate voltages necessary for the operations. The charge pump has a configuration such as shown in FIG. 2. The charge pump is a circuit that includes diodes D connected in series and capacitors C. First ends of the capacitors C are connected to the respective stages of the diodes D. Second ends of the capacitors C are supplied with clock signals. At the second ends of the capacitors C, potentials are controlled in response to the clock signals, and accordingly at the first ends of the capacitors C to which the respective diodes D are connected, potentials increase. The charge pump repeats this operation to generate a boost voltage.

FIG. 3 shows the relationship between data stored in a memory cell MC and threshold voltages. For storage of binary data, it is defined that a memory cell MC having a negative threshold voltage is a “1” cell holding logic “1” data, and a memory cell MC having a positive threshold voltage is a “0” cell holding logic “0” data. The operation for bringing the memory cell MC into the “1” data state is defined as the erase operation, and the operation for the “0” state is defined as the write operation.

[Write Operation]

FIG. 4 illustrates voltages applied to a NAND cell unit 10 in the write operation. The write operation is performed in a page basis. During the write operation, the selected word line (WL1) in the selected block BLK is applied with a write pulse voltage Vpgm (about 10 V to 25 V). Further, the nonselected word lines (WL0, WL2, WL3, . . . ,) are applied with an intermediate voltage Vpass (about 5 V to 15 V). The select gate line SG2 is applied with a voltage Vsg.

Before the write operation, the bit line BL and the NAND cell unit 10 are precharged according to write data. Specifically, when writing “0” data, the sense amplifier circuit 2 applies 0V to the bit line BL. The bit line voltage is transferred, via the select gate transistor S2 and the nonselected memory cells MC, to the channel of the memory cell MC connected to the selected word line WL1. Therefore, under the above write operation condition, charges are injected from the channel to the floating gate electrode of the selected memory cell MC, thereby shifting the threshold voltage of the memory cell MC to the positive side (“0” cell).

For the “1” write (i.e., “0” data is not written to the selected memory cell MC, the write inhibit), the bit line BL is applied with a voltage Vdd. The bit line voltage Vdd is decreased by the threshold voltage value of the select gate transistor S2 and is transferred to the channel of the NAND cell unit, and then the channel is set in the floating state. Thus, when the above write pulse voltage Vpgm or the intermediate voltage Vpass is applied, the channel voltage is increased by capacitive coupling, thereby preventing charge injection into the floating gate electrode. Thus, the memory cell MC holds “1” data.

[Read Operation]

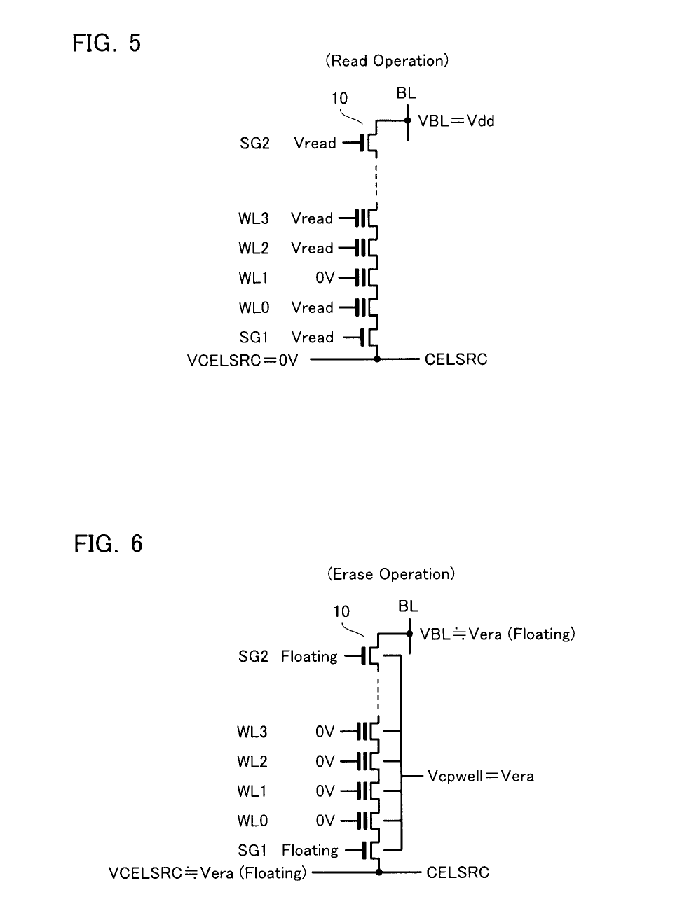

FIG. 5 illustrates voltages applied to a NAND cell unit 10 in the read operation. In the data read operation, the word line WL (the selected word line WL1) connected to the selected memory cell MC in the NAND cell unit 10 is provided with a read voltage 0V. The word lines WL (the nonselected word lines WL0, WL2, WL3, . . . ,) connected to the respective nonselected memory cells MC are applied with a read pass voltage Vread (about 3 V to 8 V). In so doing, the sense amplifier circuit 2 determines data by detecting whether or not an electric current flows through the NAND cell unit 10.

[Erase Operation]

FIG. 6 illustrates voltages applied to a NAND cell unit 10 in the erase operation. The erase operation is performed in a block basis. With reference to FIG. 6, in the erase operation, the cell well (CPWELL) is applied with an erase voltage Vera (about 10 V to 30 V), and all word lines WL in the selected block are applied with 0 V. Charges are emitted from the floating gate electrode in each memory cell MC to the cell well by the FN tunnel current, thereby reducing the threshold voltage of each memory cell MC. In so doing, the select gate lines SG1 and SG2 are set in the floating state to prevent the breakdown of the gate oxide films of the select gate transistors S1 and S2. Further, the bit line BL and the source line CELSRC are also set in the floating state.

[Voltage Generation Circuit 7]

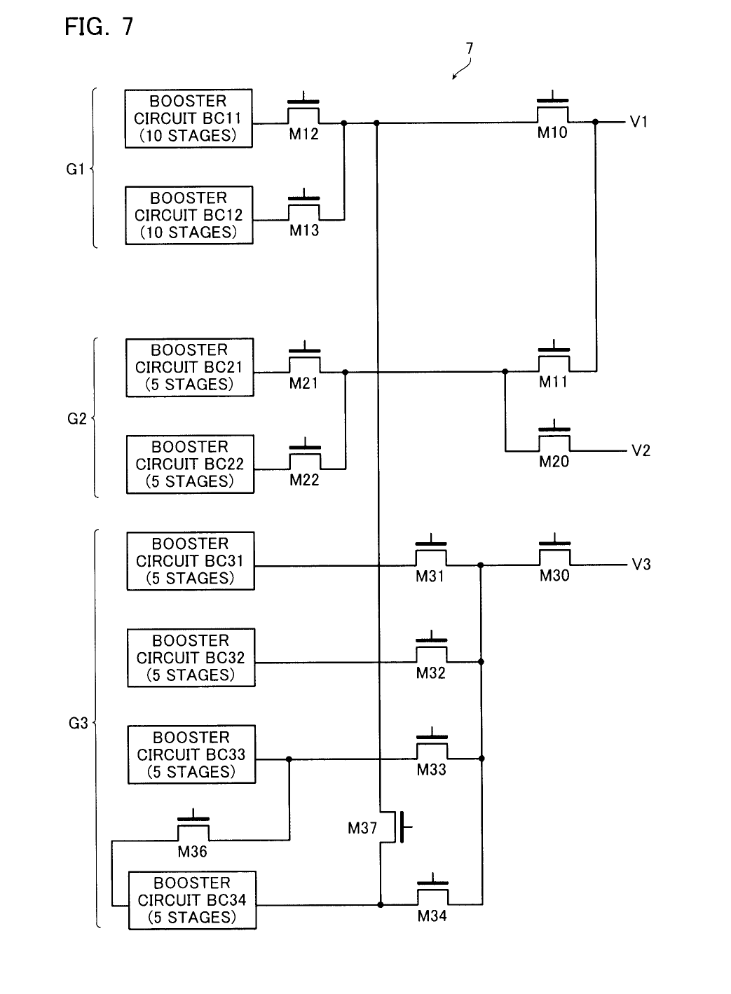

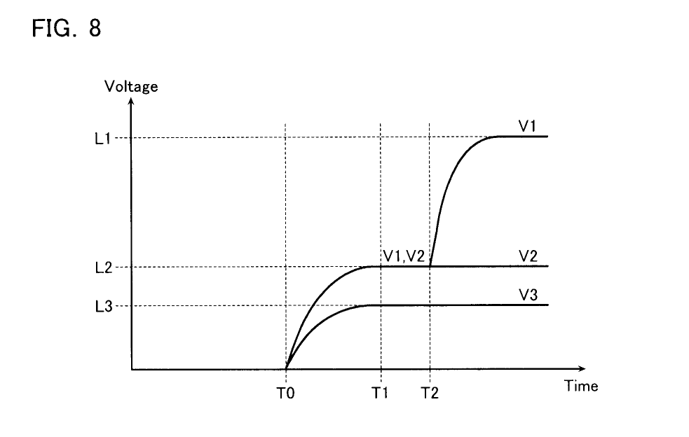

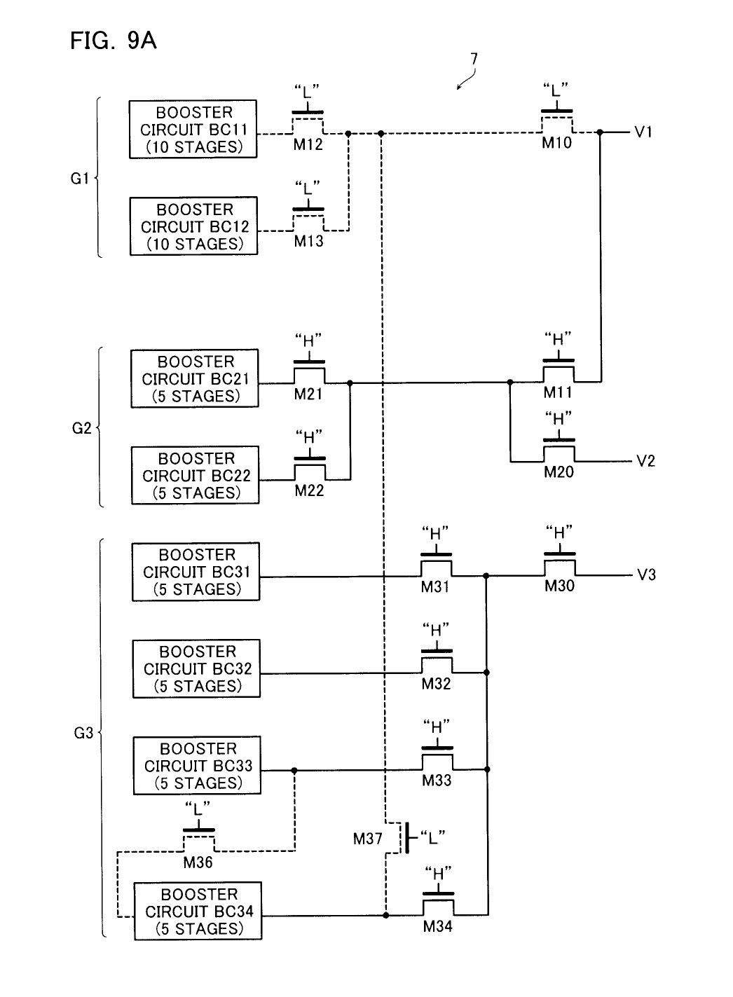

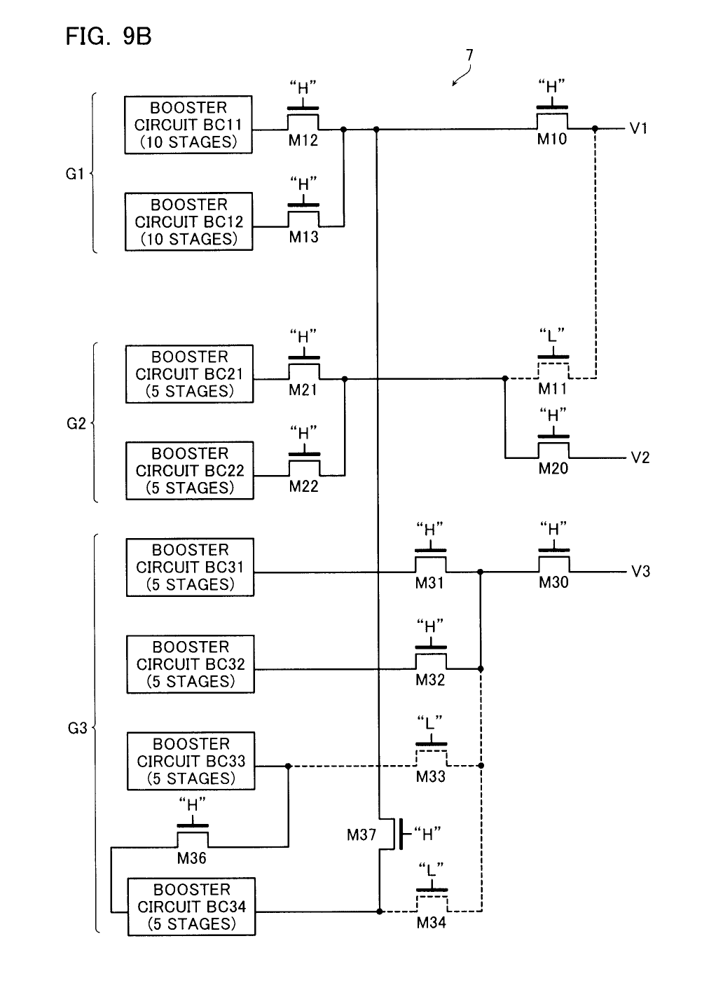

A description is given of configurations and operations of a voltage generation circuit 7. First referring to FIG. 7, a configuration of the voltage generation circuit 7 will be described. Then referring to FIG. 8, FIG. 9A, and FIG. 9B, operations of the voltage generation circuit 7 will be described.

[Configuration of Voltage Generation Circuit 7]

FIG. 7 shows the voltage generation circuit 7 according to this embodiment, which includes a booster circuit group G1 including booster circuits BC11 and BC12. Here, the booster circuits BC11 and BC12 each include, for example, a 10-stage charge pump that may generate a voltage of a certain voltage level L1. The voltage generation circuit 7 also includes a booster circuit group G2 including booster circuits BC21 and BC22. The booster circuits BC21 and BC22 each include, for example, a 5-stage charge pump that may generate a voltage of a voltage level L2 lower than the voltage level L1. The voltage generation circuit 7 also includes a booster circuit group G3 including booster circuits BC31, BC32, BC33, and BC34. The booster circuits BC31, BC32, BC33, and BC34 each include, for example, a 5-stage charge pump that may generate a voltage of the lowest voltage level L3.

The booster circuit group G1 is configured to be capable of outputting an output voltage V1 via NMOS transistors M10, M12, and M13. The booster circuit group G2 is configured to be capable of outputting an output voltage V2 via NMOS transistors M20, M21, and M22. The booster circuit group G2 may also output the output voltage V1 via an NMOS transistor M11. The booster circuit group G3 is configured to be capable of outputting an output voltage V3 via NMOS transistors M30, M31, M32, M33, and M34. Further, in the voltage generation circuit 7 according to this embodiment, NMOS transistors M36 and M37 are provided to allow the booster circuit BC33 and the booster circuit BC34 in the booster circuit group G3 to output the output voltage V1.

[Operations of Voltage Generation Circuit 7]

FIG. 8 is a timing diagram illustrating an example operation of the voltage generation circuit 7. Further, FIG. 9A and FIG. 9B illustrate configurations and operations of the voltage generation circuit 7.

As described above, in the operations of the NAND flash memory, various types of voltages are generated and applied to wiring lines that need the voltages. FIG. 8 shows a timing diagram illustrating a timing when the output voltages V1, V2, and V3 of the voltage generation circuit 7 are increased to the respective voltage levels L1, L2, and L3. For example, for the write operation shown in FIG. 4, the voltage levels L1, L2, and L3 are as follows: the voltage level L1 corresponds to the voltage value of the write pulse voltage Vpgm, the voltage level L2 to the voltage value of the intermediate voltage Vpass, and the voltage level L3 to the voltage value of the select gate line voltage Vsg.

At time T0, the voltage generation circuit 7 starts to operate and the output voltages V1, V2, and V3 start to increase. At time T1, the output voltages V1 and V2 reach the voltage level L2. The voltages V1 and V2 both remain at the voltage level L2 until time T2. Further, at time T1, the output voltage V3 reaches the voltage level L3, and then remains at the voltage level L3.

FIG. 9A shows an operation of the voltage generation circuit 7 in a first state from time T0 to time T2 in FIG. 8. With reference to FIG. 9A, the booster circuit group G2 supplies the output voltages V1 and V2 via the NMOS transistors M11, M20, M21, and M22 in conductive state. Here, the booster circuit group G2 is configured to generate a voltage of the voltage level L2, and so the output voltages V1 and V2 both increase to a voltage of the voltage level L2. Further, with reference to FIG. 9A, the booster circuit group G3 supplies the output voltage V3 via the NMOS transistors M30, M31, M32, M33, and M34 in conductive state. The booster circuit group G3 is configured to generate a voltage of the voltage level L3, and so the output voltage V3 increases to a voltage of the voltage level L3. In so doing, the NMOS transistors M36 and M37 are rendered non-conductive.

After time T1 when the output voltages V1, V2, and V3 are increased, the voltage generation circuit 7 maintains the voltage values of the output voltages V1, V2, and V3. In so doing, some booster circuits in the booster circuit groups G2 and G3 may be stopped (not shown).

Next, at time T2 in FIG. 8, the output voltage V1 starts to further increase from the voltage level L2 to the voltage level L1. Then, the output voltage V1 reaches the voltage level L1, and the boost operation in the voltage generation circuit 7 ends. In the above write operation, the bit line voltage (0 V or voltage Vdd) is transferred to the channel via the select gate transistor S2 applied with the select gate line voltage Vsg and the nonselected memory cell MC applied with the intermediate voltage Vpass, and then the write pulse voltage Vpgm is applied. Therefore, the output voltage V1 may be increased at a timing delayed from the increases of the output voltages V2 and V3.

FIG. 9B shows an operation of the voltage generation circuit 7 in a second state after time T2 in FIG. 8. With reference to FIG. 9B, the booster circuit group G1 supplies the output voltage V1 via the NMOS transistors M10, M12, and M13 in conductive state. Here, the booster circuit group G2 is configured to generate a voltage of the voltage level L2, and so it may not increase the output voltage V1 to a voltage of the voltage level L1. Therefore, at time T2, the NMOS transistor M11 is rendered non-conductive and thus the booster circuit group G2 stops the boost operation of the output voltage V1. The booster circuits BC21 and BC22 in the booster circuit group G2 supply voltages via the NMOS transistors M20, M21, and M22 in conductive state, thereby maintaining the output voltage V2 at the voltage level L2.

Further, with reference to FIG. 9B, the booster circuits BC31 and BC32 in the booster circuit group G3 supply voltages via the NMOS transistors M30, M31, and M32 in conductive state, thereby maintaining the output voltage V3 at the voltage level L3. In this embodiment, the NMOS transistors M33 and M34 are rendered non-conductive, and thus the booster circuits BC33 and BC34 stop the boost operation of the output voltage V3. In this embodiment, at this time T2, the NMOS transistors M36 and M37 are rendered conductive, and thus the booster circuits BC33 and BC34 perform the boost operation of the output voltage V1. Here, the NMOS transistors M36 and M37 are configured to connect the booster circuits BC33 and BC34 in series. Therefore, the booster circuits BC33 and BC34 have a boost capability equivalent to a booster circuit including 10-stage charge pumps connected. As a result, the booster circuits BC33 and BC34 may perform the boost operation of the output voltage V1 together with the booster circuits BC11 and BC12.

[Effects]

The voltage generation circuit 7 according to this embodiment uses, from some midpoint in the boost operation (for example, from time T2 in FIG. 8), the booster circuits BC33 and BC34 for the boost operation of the output voltage V1 instead of the boost operation of the output voltage V3. The booster circuits provided in the booster circuit group G1 each include many charge-pump stages, which occupy a large circuit area. The booster circuits BC33 and BC34 used for the boost operation of the output voltage V1 may decrease the number of booster circuits in the booster circuit group G1.

As a result, the circuit area necessary for the voltage generation circuit 7 may be reduced. Further, the booster circuits BC33 and BC34 are connected in series at time T2. Therefore, they may also perform the boost operation of the output voltage V1 that needs to be boosted up to the voltage level L1 of the highest voltage value.

### Second Embodiment

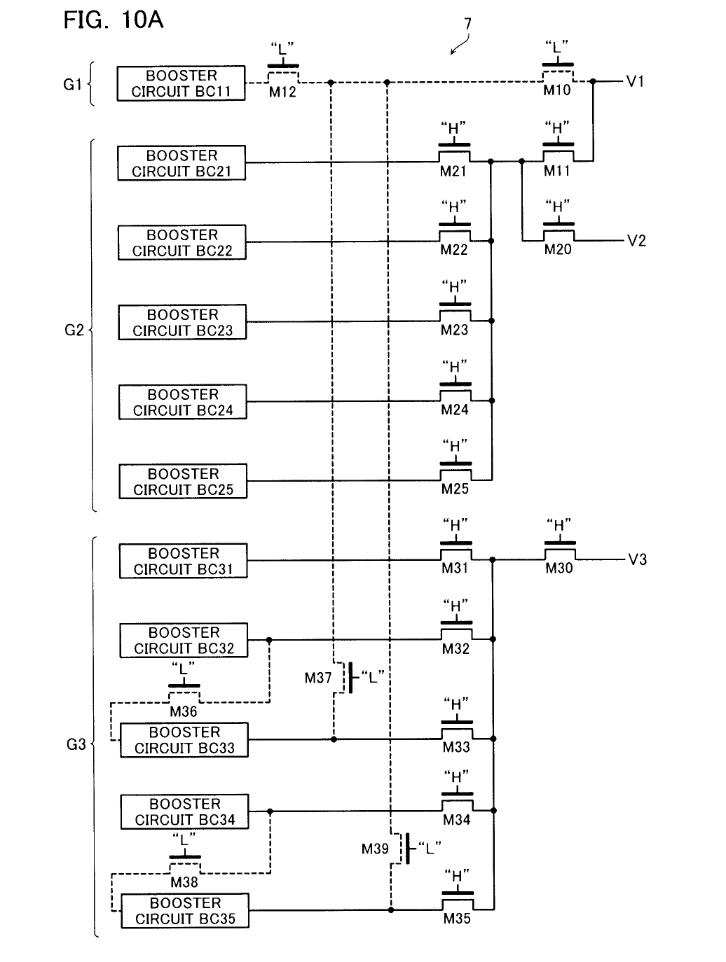

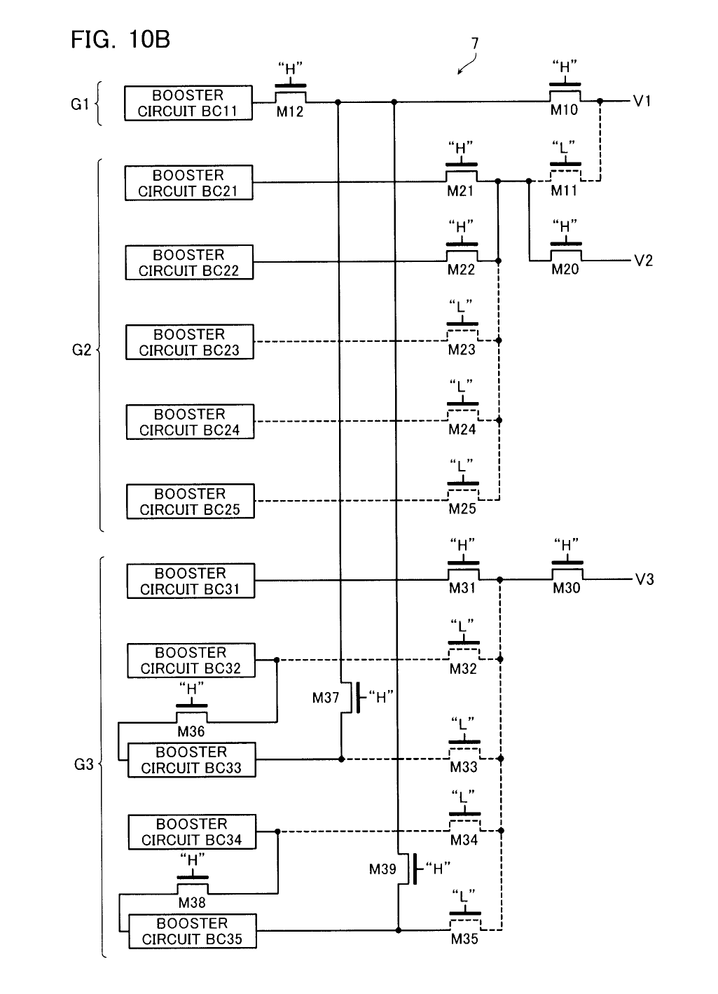

Referring now to FIG. 10A and FIG. 10B, a nonvolatile semiconductor memory device according to a second embodiment will be described. The entire configuration of the nonvolatile semiconductor memory device according to this embodiment is similar to that in the first embodiment, and thus the detailed description thereof is omitted here. Like elements as those in the first embodiment are designated by like reference numerals, and repeated description thereof is omitted here.

The voltage generation circuit 7 according to the second embodiment shown in FIG. 10A and FIG. 10B is different from the voltage generation circuit 7 according to the first embodiment shown in FIG. 9A and FIG. 9B in that the booster circuit BC12 and the NMOS transistor M13 are omitted. Further, the voltage generation circuit 7 according to the second embodiment includes more booster circuits in the booster circuit groups G2 and G3 than that in the first embodiment. Additionally, in the voltage generation circuit 7 according to the second embodiment, the NMOS transistors M36 and M37 and NMOS transistors M38 and M39 are provided to allow the booster circuits BC32 and BC33 and booster circuits BC34 and BC35 in the booster circuit group G3 to output the output voltage V1, respectively, unlike the voltage generation circuit 7 according to the first embodiment.

FIG. 10A shows an operation of the voltage generation circuit 7 in the first state from time T0 to time T2 in FIG. 8. With reference to FIG. 10A, the booster circuit group G2 supplies the output voltages V1 and V2 via the NMOS transistors M11, M20, M21, M22, M23, M24, and M25 in conductive state. Further, with reference to FIG. 10A, the booster circuit group G3 supplies the output voltage V3 via the NMOS transistors M30, M31, M32, M33, M34, and M35 in conductive state. In so doing, the NMOS transistors M36, M37, M38, and M39 are rendered non-conductive.

After time T1 when the output voltages V1, V2, and V3 are increased, the voltage generation circuit 7 maintains the voltage values of the output voltages V1, V2, and V3. In so doing, some booster circuits in the booster circuit groups G2 and G3 may be stopped (not shown).

FIG. 10B shows an operation of the voltage generation circuit 7 in the second state after time T2 in FIG. 8. With reference to FIG. 10B, the booster circuit group G1 supplies the output voltage V1 via the NMOS transistors M10 and M12 in conductive state. At time T2, the NMOS transistor M11 is rendered non-conductive, and thus the booster circuit group G2 stops the boost operation of the output voltage V1. The booster circuits BC21 and BC22 in the booster circuit group G2 supply voltages via the NMOS transistors M20, M21, and M22 in conductive state, thereby maintaining the output voltage V2 at the voltage level L2. The NMOS transistors M23, M24, and M25 are rendered non-conductive, and thus the booster circuits BC23, BC24, and BC25 stop the boost operation of the output voltage V2.

Further, with reference to FIG. 10B, the booster circuit BC31 in the booster circuit group G3 supplies a voltage via the NMOS transistors M30 and M31 in conductive state, thereby maintaining the output voltage V3 at the voltage level L3. In this embodiment, the NMOS transistors M32, M33, M34, and M35 are rendered non-conductive, and thus the booster circuits BC32, BC33, BC34, and BC35 stop the boost operation of the output voltage V3. In this embodiment, at this time T2, the NMOS transistors M36, M37, M38, and M39 are rendered conductive, and thus the booster circuits BC32 and BC33 and the booster circuits BC34 and BC35 perform the boost operation of the output voltage V1. Here, the NMOS transistors M36 and M37 are configured to connect the booster circuits BC32 and BC33 in series. Further, the NMOS transistors M38 and M39 are configured to connect the booster circuits BC34 and BC35 in series. Therefore, the booster circuits BC32 and BC33 and the booster circuits BC34 and BC35 respectively have a boost capability equivalent to a booster circuit including 10-stage charge pumps connected. As a result, the booster circuits BC32 and BC33 and the booster circuits BC34 and BC35 may perform the boost operation of the output voltage V1 together with the booster circuit BC11.

[Effects]

As described above, in the operation of the voltage generation circuit 7 such as the write operation, the output voltages V2 and V3 correspond to the intermediate voltage Vpass applied to the nonselected word lines WL and the voltage Vsg applied to the select gate lines SG1 and SG2. When there are many select gate lines SG1 and SG2 and nonselected word lines WL, many booster circuits are provided in the booster circuit groups G2 and G3. In this case, the number of booster circuits increase that may be used for the boost operation of the output voltage V1 from some midpoint in the boost operation. In this embodiment, the booster circuit group G3 includes two sets of series-connected booster circuits: the booster circuits BC32 and BC33; and the booster circuits BC34 and BC35. Therefore, the number of booster circuits provided in the booster circuit group G1 may further be decreased. It should be appreciated that three or more sets of series-connected booster circuits may be provided in one booster circuit group.

### Third Embodiment

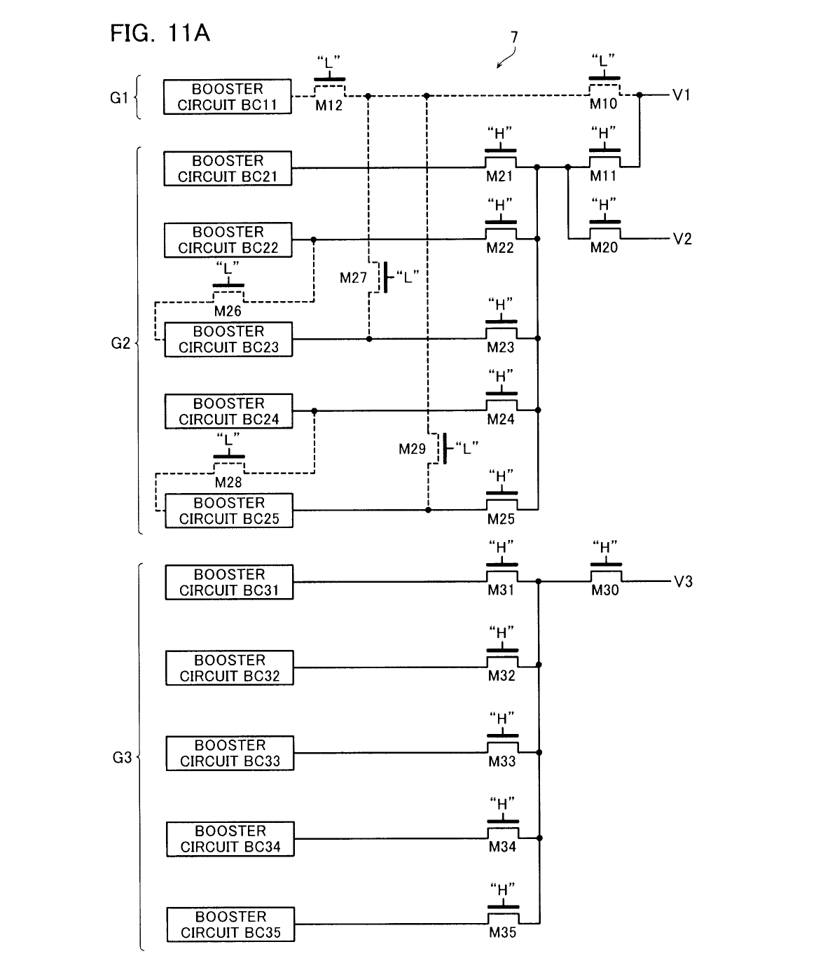

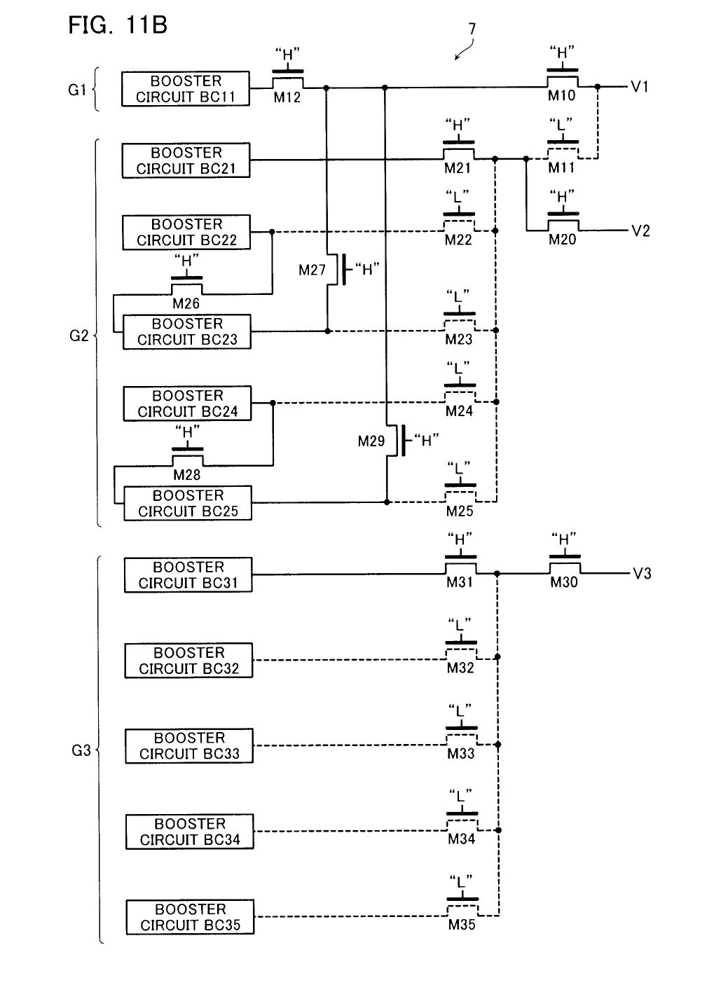

Referring now to FIG. 11A and FIG. 11B, a nonvolatile semiconductor memory device according to a third embodiment will be described. The entire configuration of the nonvolatile semiconductor memory device according to this embodiment is similar to that in the first embodiment, and thus the detailed description thereof is omitted here. Like elements as those in the first embodiment are designated by like reference numerals, and repeated description thereof is omitted here.

The voltage generation circuit 7 according to the third embodiment shown in FIG. 11A and FIG. 11B is different from the voltage generation circuit 7 according to the second embodiment in that the NMOS transistors M36, M37, M38, and M39 that are configured to allow the booster circuits in the booster circuit group G3 to output the output voltage V1 are omitted. In the voltage generation circuit 7 according to the third embodiment, NMOS transistors M26 and M27 and NMOS transistors M28 and M29 are provided to allow the booster circuits BC22 and BC23 and the booster circuits BC24 and BC25 in the booster circuit group G2 to output the output voltage V1, respectively, unlike the voltage generation circuit 7 according to the second embodiment.

FIG. 11A shows an operation of the voltage generation circuit 7 in the first state from time T0 to time T2 in FIG. 8. With reference to FIG. 11A, the booster circuit group G2 supplies the output voltages V1 and V2 via the NMOS transistors M11, M20, M21, M22, M23, M24, and M25 in conductive state. In so doing, the NMOS transistors M26, M27, M28, and M29 are rendered non-conductive. Further, with reference to FIG. 11A, the booster circuit group G3 supplies the output voltage V3 via the NMOS transistors M30, M31, M32, M33, M34, and M35 in conductive state.

After time T1 when the output voltages V1, V2, and V3 are increased, the voltage generation circuit 7 maintains the voltage values of the output voltages V1, V2, and V3. In so doing, some booster circuits in the booster circuit groups G2 and G3 may be stopped (not shown).

FIG. 11B shows an operation of the voltage generation circuit 7 in the second state after time T2 in FIG. 8. With reference to FIG. 11B, the booster circuit group G1 supplies the output voltage V1 via the NMOS transistors M10 and M12 in conductive state. At time T2, the NMOS transistor M11 is rendered non-conductive, and thus the booster circuit group G2 stops the boost operation of the output voltage V1. The booster circuit BC21 in the booster circuit group G2, supplies a voltage via the NMOS transistors M20 and M21 in conductive state, thereby maintaining the output voltage V2 at the voltage level L2. In this embodiment, the NMOS transistors M22, M23, M24, and M25 are rendered non-conductive, and thus the booster circuits BC22, BC23, BC24, and BC25 stop the boost operation of the output voltage V2. In this embodiment, at this time T2, the NMOS transistors M26, M27, M28, and M29 are rendered conductive, and thus the booster circuits BC22 and BC23 and the booster circuits BC24 and BC25 perform the boost operation of the output voltage V1. Here, the NMOS transistors M26 and M27 are configured to connect the booster circuits BC22 and BC23 in series. Further, the NMOS transistors M28 and M29 are configured to connect the booster circuits BC24 and BC25 in series. Therefore, the booster circuits BC22 and BC23 and the booster circuits BC24 and BC25 respectively have a boost capability equivalent to a booster circuit including 10-stage charge pumps connected. As a result, the booster circuits BC22 and BC23 and the booster circuits BC24 and BC25 may perform the boost operation of the output voltage V1 together with the booster circuit BC11.

Further, with reference to FIG. 11B, the booster circuit BC31 in the booster circuit group G3 supplies a voltage via the NMOS transistors M30 and M31 in conductive state, thereby maintaining the output voltage V3 at the voltage level L3. The NMOS transistors M32, M33, M34, and M35 are rendered non-conductive, and thus the booster circuits BC32, BC33, BC34, and BC35 stop the boost operation of the output voltage V3.

[Effects]

In this embodiment, the booster circuits used for the boost operation of the output voltage V1 from some midpoint in the boost operation (for example, from time T2 in FIG. 8) are two sets of booster circuits provided in the booster circuit group G2: the booster circuits BC22 and BC23; and the booster circuits BC24 and BC25. This embodiment may also decrease the number of booster circuits provided in the booster circuit group G1. It should be appreciated that three or more sets of series-connected booster circuits may be provided in one booster circuit group.

### Fourth Embodiment

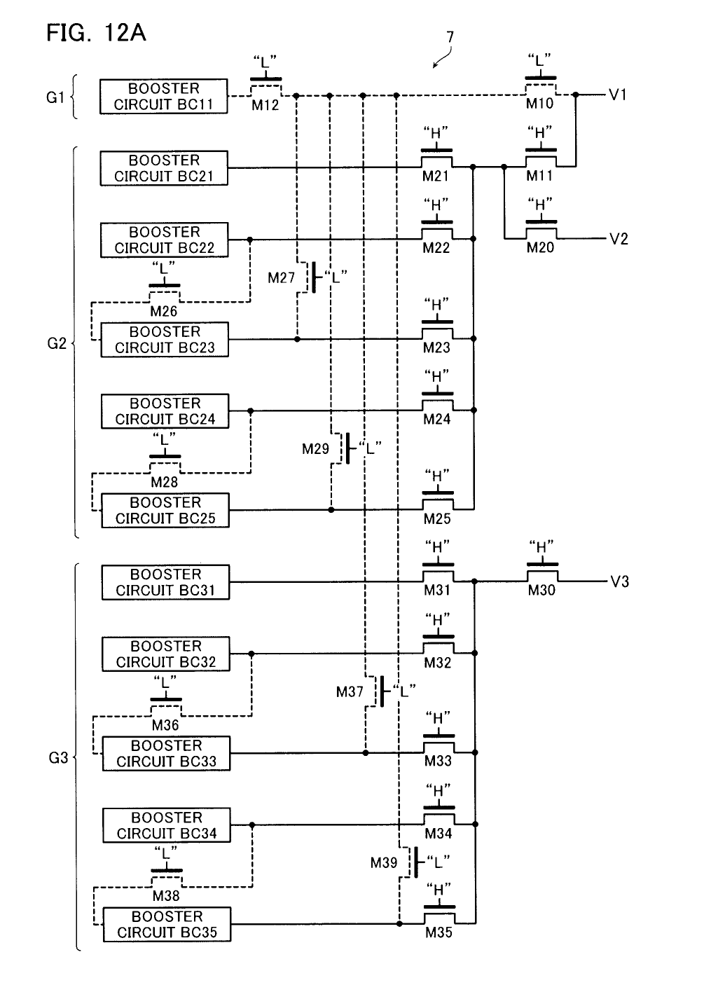

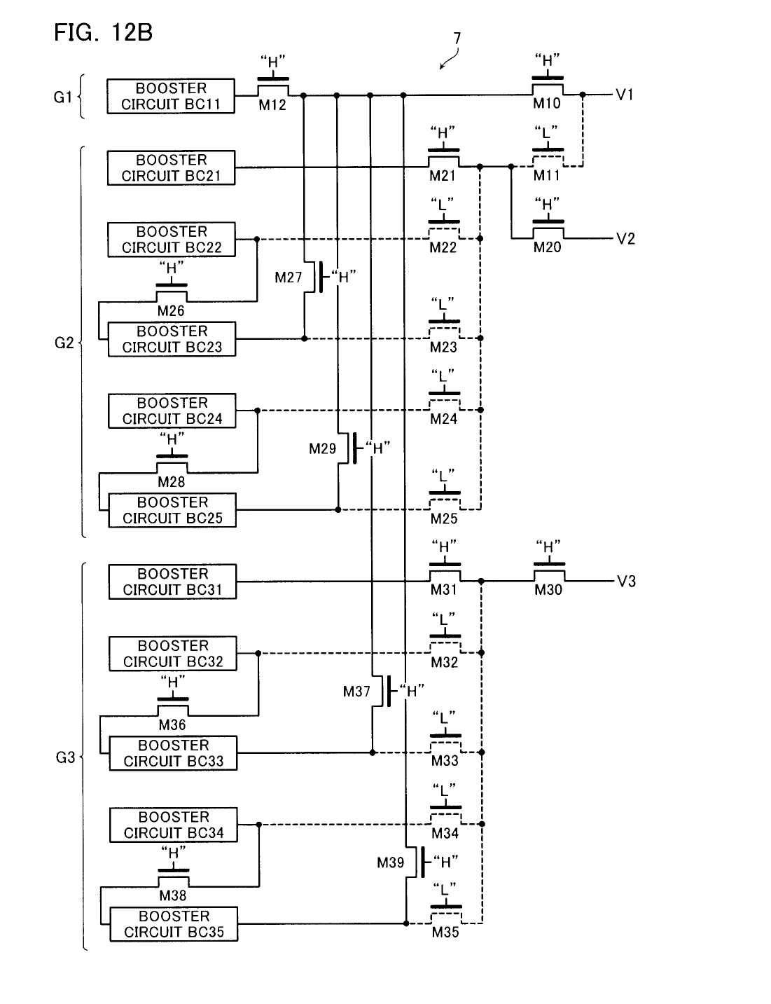

Referring now to FIG. 12A and FIG. 12B, a nonvolatile semiconductor memory device according to a fourth embodiment will be described. The entire configuration of the nonvolatile semiconductor memory device according to this embodiment is similar to that in the first embodiment, and thus the detailed description thereof is omitted here. Like elements as those in the first embodiment are designated by like reference numerals, and repeated description thereof is omitted here.

The voltage generation circuit 7 according to the fourth embodiment shown in FIG. 12A and FIG. 12B includes a combination of the voltage generation circuit 7 according to the second embodiment shown in FIG. 10A and FIG. 10B and the voltage generation circuit 7 according to the third embodiment shown in FIG. 11A and FIG. 11B.

FIG. 12A shows an operation of the voltage generation circuit 7 in the first state from time T0 to time T2 in FIG. 8. With reference to FIG. 12A, the booster circuit group G2 supplies the output voltages V1 and V2 via the NMOS transistors M11, M20, M21, M22, M23, M24, and M25 in conductive state. Further, with reference to FIG. 12A, the booster circuit group G3 supplies the output voltage V3 via the NMOS transistors M30, M31, M32, M33, M34, and M35 in conductive state. In so doing, the NMOS transistor M26 to M29 and M36 to M39 are rendered non-conductive.

After time T1 when the output voltages V1, V2, and V3 are increased, the voltage generation circuit 7 maintains the voltage values of the output voltages V1, V2, and V3. In so doing, some booster circuits in the booster circuit groups G2 and G3 may be stopped (not shown).

FIG. 12B shows an operation of the voltage generation circuit 7 in the second state after time T2 in FIG. 8. With reference to FIG. 12B, the booster circuit group G1 supplies the output voltage V1 via the NMOS transistors M10 and M12 in conductive state. At time T2, the NMOS transistor M11 is rendered non-conductive, and thus the booster circuit group G2 stops the boost operation of the output voltage V1. The booster circuit BC21 in the booster circuit group G2 supplies a voltage via the NMOS transistors M20 and M21 in conductive state, thereby maintaining the output voltage V2 at the voltage level L2. In this embodiment, the NMOS transistors M22, M23, M24, and M25 are rendered non-conductive, and thus the booster circuits BC22, BC23, BC24, and BC25 stop the boost operation of the output voltage V2. In this embodiment, at this time T2, the NMOS transistors M26, M27, M28, and M29 are rendered conductive, and thus the booster circuits BC22 and BC23 and the booster circuits BC24 and BC25 perform the boost operation of the output voltage V1. Here, the NMOS transistors M26 and M27 are configured to connect the booster circuits BC22 and BC23 in series. Further, the NMOS transistors M28 and M29 are configured to connect the booster circuits BC24 and BC25 in series. Therefore, the booster circuits BC22 and BC23 and the booster circuits BC24 and BC25 respectively have a boost capability equivalent to a booster circuit including 10-stage charge pumps connected. As a result, the booster circuits BC22 and BC23 and the booster circuits BC24 and BC25 may perform the boost operation of the output voltage V1 together with the booster circuit BC11.

Further, with reference to FIG. 12B, the booster circuit BC31 in the booster circuit group G3 supplies a voltage via the NMOS transistors M30 and M31 in conductive state, thereby maintaining the output voltage V3 at the voltage level L3. In this embodiment, the NMOS transistors M32, M33, M34, and M35 are rendered non-conductive, and thus the booster circuits BC32, BC33, BC34, and BC35 stop the boost operation of the output voltage V3. In this embodiment, at this time T2, the NMOS transistors M36, M37, M38, and M39 are rendered conductive, and thus the booster circuits BC32 and BC33 and the booster circuits BC34 and BC35 perform the boost operation of the output voltage V1. Here, the NMOS transistors M36 and M37 are configured to connect the booster circuits BC32 and BC33 in series. Further, the NMOS transistors M38 and M39 are configured to connect the booster circuits BC34 and BC35 in series. Therefore, the booster circuits BC32 and BC33 and the booster circuits BC34 and BC35 respectively have a boost capability equivalent to a booster circuit including 10-stage charge pumps connected. As a result, the booster circuits BC32 and BC33 and the booster circuits BC34 and BC35 may perform the boost operation of the output voltage V1 together with the booster circuit BC11, the booster circuits BC22 and BC23, and the booster circuits BC24 and BC25.

[Effects]

In this embodiment, the booster circuit group G2 includes two sets of series-connected booster circuits: the booster circuits BC22 and BC23; and the booster circuits BC24 and BC25. Further, the booster circuit group G3 includes two sets of series-connected booster circuits: the booster circuits BC32 and BC33; and the booster circuits BC34 and BC35. The voltage generation circuit according to this embodiment may further decrease the number of booster circuits provided in the booster circuit group G1. It should be appreciated that three or more sets of series-connected booster circuits may be provided in one booster circuit group.

### Fifth Embodiment

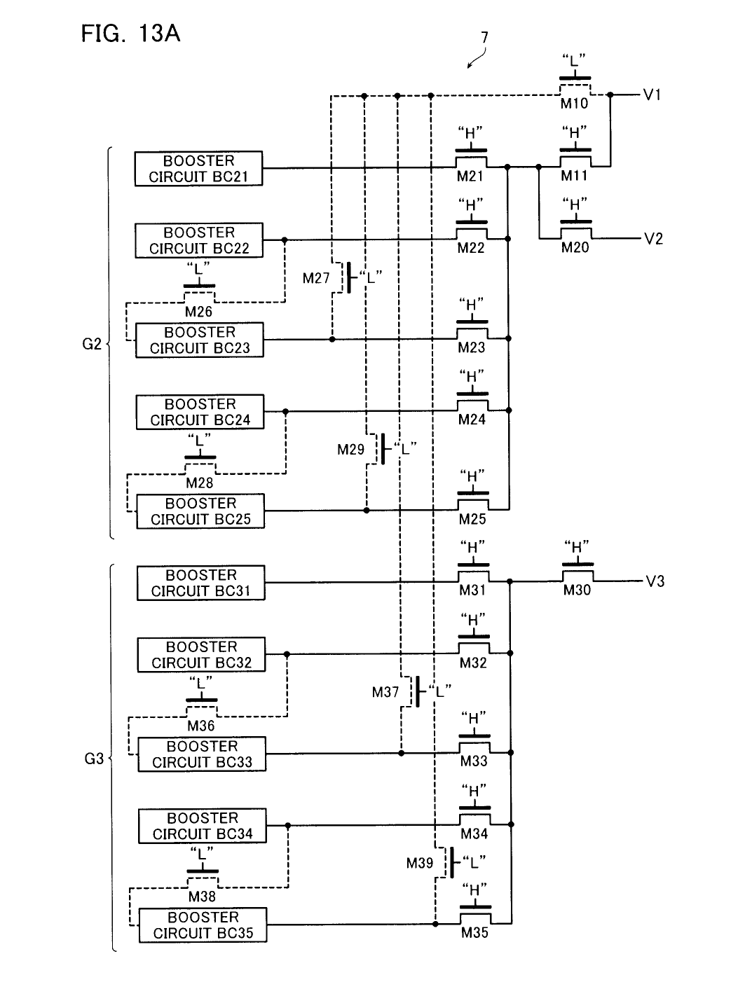

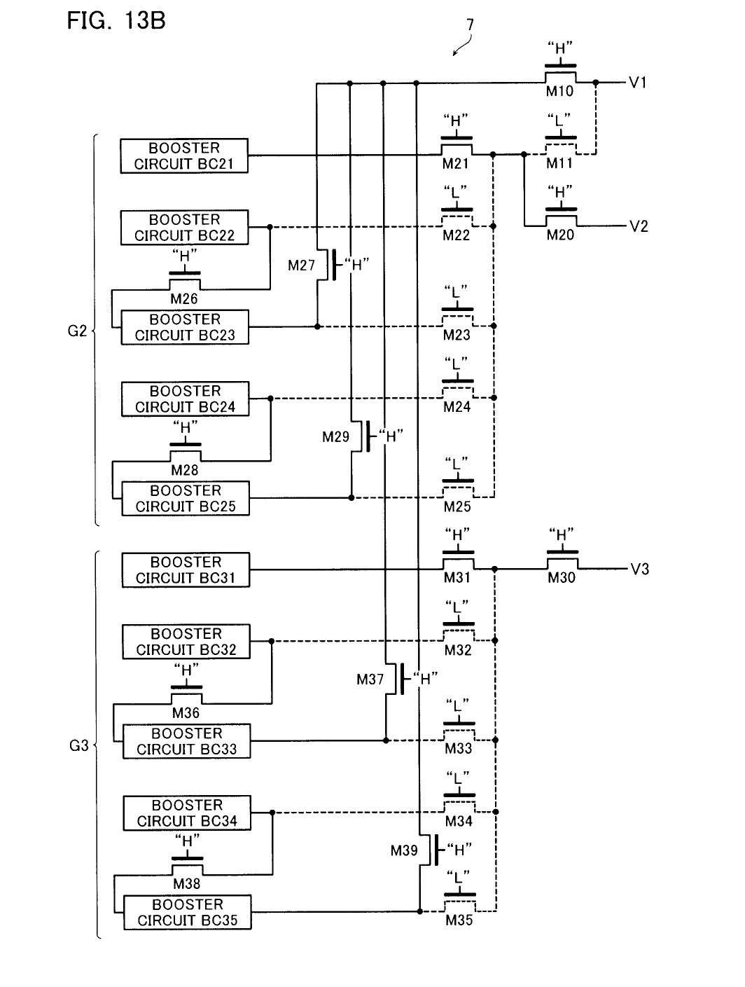

Referring now to FIG. 13A and FIG. 13B, a nonvolatile semiconductor memory device according to a fifth embodiment will be described. The entire configuration of the nonvolatile semiconductor memory device according to this embodiment is similar to that in the first embodiment, and thus the detailed description thereof is omitted here. Like elements as those in the first embodiment are designated by like reference numerals, and repeated description thereof is omitted here.

The voltage generation circuit 7 according to the fifth embodiment shown in FIG. 13A and FIG. 13B is different from the voltage generation circuit 7 according to the fourth embodiment shown in FIG. 12A and FIG. 12B in that the booster circuit BC11 and the NMOS transistor M12 in the booster circuit group G1 are omitted.

FIG. 13A shows an operation of the voltage generation circuit 7 in the first state from time T0 to time T2 in FIG. 8. With reference to FIG. 13A, the booster circuit group G2 supplies the output voltages V1 and V2 via the NMOS transistors M11, M20, M21, M22, M23, M24, and M25 in conductive state. Further, with reference to FIG. 13A, the booster circuit group G3 supplies the output voltage V3 via the NMOS transistors M30, M31, M32, M33, M34, and M35 in conductive state. In so doing, the NMOS transistors M26 to M29 and M36 to M39 are rendered non-conductive.

After time T1 when the output voltages V1, V2, and V3 are increased, the voltage generation circuit 7 maintains the voltage values of the output voltages V1, V2, and V3. In so doing, some booster circuits in the booster circuit groups G2 and G3 may be stopped (not shown).

FIG. 13B shows an operation of the voltage generation circuit 7 in the second state after time T2 in FIG. 8. With reference to FIG. 13B, at time T2, the NMOS transistor Mil is rendered non-conductive, and thus the booster circuit group G2 stops the boost operation of the output voltage V1. The booster circuit BC21 in the booster circuit group G2 supplies a voltage via the NMOS transistors M20 and M21 in conductive state, thereby maintaining the output voltage V2 at the voltage level L2. In this embodiment, the NMOS transistors M22, M23, M24, and M25 are rendered non-conductive, and thus the booster circuits BC22, BC23, BC24, and BC25 stop the boost operation of the output voltage V2. In this embodiment, at this time T2, the NMOS transistors M26, M27, M28, and M29 are rendered conductive, and thus the booster circuits BC22 and BC23 and the booster circuits BC24 and BC25 perform the boost operation of the output voltage V1. Here, the NMOS transistors M26 and M27 are configured to connect the booster circuits BC22 and BC23 in series. Further, the NMOS transistors M28 and M29 are configured to connect the booster circuits BC24 and BC25 in series. Therefore, the booster circuits BC22 and BC23 and the booster circuits BC24 and BC25 respectively have a boost capability equivalent to a booster circuit including 10-stage charge pumps connected. As a result, the booster circuits BC22 and BC23 and the booster circuits BC24 and BC25 may perform the boost operation of the output voltage V1.

Further, with reference to FIG. 13B, the booster circuit BC31 in the booster circuit group G3 supplies a voltage via the NMOS transistors M30 and M31 in conductive state, thereby maintaining the output voltage V3 at the voltage level L3. In this embodiment, the NMOS transistors M32, M33, M34, and M35 are rendered non-conductive, and thus the booster circuits BC32, BC33, BC34, and BC35 stop the boost operation of the output voltage V3. In this embodiment, at this time T2, the NMOS transistors M36, M37, M38, and M39 are rendered conductive, and thus the booster circuits BC32 and BC33 and the booster circuits BC34 and BC35 perform the boost operation of the output voltage V1. Here, the NMOS transistors M36 and M37 are configured to connect the booster circuits BC32 and BC33 in series. Further, the NMOS transistors M38 and M39 are configured to connect the booster circuits BC34 and BC35 in series. Therefore, the booster circuits BC32 and BC33 and the booster circuits BC34 and BC35 respectively have a boost capability equivalent to a booster circuit including 10-stage charge pumps connected. As a result, the booster circuits BC32 and BC33 and the booster circuits BC34 and BC35 may perform the boost operation of the output voltage V1 together with the booster circuits BC22 and BC23 and the booster circuits BC24 and BC25.

[Effects]

The voltage generation circuit 7 according to this embodiment uses the booster circuits BC22 to BC25 and BC32 to BC35 for the boost operation of the output voltage V1 from some midpoint in the boost operation (from time T2 in FIG. 8). If the booster circuits BC22 to BC25 and BC32 to BC35 may sufficiently boost up the output voltage, the booster circuit group G1 may be omitted. As a result, the circuit area necessary for the voltage generation circuit 7 may further be reduced.

[Others]

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the above embodiments is described with respect to two booster circuits BC connected in series. However, the number of series-connected booster circuits BC may be three or more as necessary. Further, the number of sets of series-connected booster circuits BC provided in one booster circuit group G may be three or more as necessary. Additionally, although the above embodiments is described with respect to a nonvolatile semiconductor device of the binary storage scheme (1-bit data/cell), it will be understood that the present invention is not limited thereto and is also applicable to a more bit storage scheme such as the four-value storage scheme and the eight-value storage scheme.

What is claimed is:

1. A voltage generation circuit comprising:
a first booster circuit configured to generate a first voltage having a first voltage value; and
a second booster circuit group including a plurality of second booster circuits, each second booster circuit configured to generate a second voltage having a second voltage value,
the second booster circuits switching to be connected in series and being configured to be capable of generating the first voltage together with the first booster circuit in a change from a first state to a second state.

2. The voltage generation circuit according to claim 1, wherein
some of the second booster circuits included in the second booster circuit group switch to be connected in series in the second state.

3. The voltage generation circuit according to claim 1, wherein
the first voltage value is greater than the second voltage value.

4. The voltage generation circuit according to claim 1, wherein
each of the first booster circuit and the second booster circuits has a charge pump including a plurality of diodes connected in series and a plurality of capacitors, first ends of the capacitors being connected to respective stages of the diodes and second ends of the capacitors being supplied with clock signals, and
the number of the stages of the charge pump in the first booster circuit is greater than the number of the stages of the charge pump in each one of the second booster circuits.

5. The voltage generation circuit according to claim 1, further comprising a third booster circuit group including a plurality of third booster circuits, each third booster circuit being configured to generate a third voltage having a third voltage value.

6. The voltage generation circuit according to claim 5, wherein
the third booster circuits switch to be connected in series and are configured to be capable of generating the first voltage together with the first booster circuit in the change from the first state to the second state.

7. The voltage generation circuit according to claim 6, wherein
some of the third booster circuits included in the third booster circuit group switch to be connected in series in the second state.

8. The voltage generation circuit according to claim 5, wherein
the first voltage value is greater than the second voltage value and than the third voltage value.

9. The voltage generation circuit according to claim 5, wherein
each of the first booster circuit, the second booster circuits, and the third booster circuits has a charge pump including a plurality of diodes connected in series and a plurality of capacitors, first ends of the capacitors being connected to respective stages of the diodes and second ends of the capacitors being supplied with clock signals, and
the number of the stages of the charge pump in the first booster circuit is greater than the number of the stages of the charge pump in each one of the second booster circuits and than the number of the stages of the charge pump in each one of the third booster circuits.

10. A voltage generation circuit comprising:
a first booster circuit group including a plurality of first booster circuits, each first booster circuit being configured to generate a first voltage having a first voltage value; and
a second booster circuit group including a plurality of second booster circuits, each second booster circuit being configured to generate a second voltage having a second voltage value,
some of the first booster circuits switching to be connected in series and being configured to be capable of generating the third voltage having a third voltage value in a change from a first state to a second state.

11. The voltage generation circuit according to claim 10, wherein
some of the second booster circuits switch to be connected in series and are configured to be capable of generating the third voltage in the change from the first state to the second state.

12. The voltage generation circuit according to claim 10, wherein
the third voltage value is greater than the first voltage value and than the second voltage value.

13. The voltage generation circuit according to claim 10, wherein
each of the first booster circuits and the second booster circuits has a charge pump including a plurality of diodes connected in series and a plurality of capacitors, first ends of the capacitors being connected to respective stages of the diodes and second ends of the capacitors being supplied with clock signals, and
the number of the stages of the charge pump in one of the first booster circuits is equal to the number of the stages of the charge pump in one of the second booster circuits.

14. A voltage generation circuit comprising:
a first booster circuit configured to generate a first voltage having a first voltage value; and
a second booster circuit group including a plurality of second booster circuits, each second booster circuit being configured to generate a second voltage having a second voltage value,
in a first state, the second booster circuit group outputting the second voltage as an output voltage of the first booster circuit and the second booster circuit group,
in a second state after the first state, the first booster circuit outputting the first voltage and some of the second booster circuits outputting the second voltage, and
the others of the second booster circuits switching to be connected in series and being configured to be capable of generating the first voltage together with the first booster circuit in a change from the first state to the second state.

15. The voltage generation circuit according to claim 14, wherein
the first voltage value is greater than the second voltage value.

16. The voltage generation circuit according to claim 14, wherein
each of the first booster circuit and the second booster circuits has a charge pump including a plurality of diodes connected in series and a plurality of capacitors, first ends of the capacitors being connected to respective stages of the diodes and second ends of the capacitors being supplied with clock signals, and
the number of the stages of the charge pump in the first booster circuit is greater than the number of the stages of the charge pump in each one of the second booster circuits.

17. The voltage generation circuit according to claim 14, further comprising a third booster circuit group including a plurality of third booster circuits, each third booster circuit being configured to generate a third voltage having a third voltage value.

18. The voltage generation circuit according to claim 17, wherein
in the first state, the third booster circuit group outputs the third voltage,
in the second state, some of the third booster circuits output the third voltage, and
the others of the third booster circuits switch to be connected in series and are configured to be capable of generating the first voltage together with the first booster circuit in the change from the first state to the second state.

19. The voltage generation circuit according to claim 17, wherein
the first voltage value is greater than the second voltage value and than the third voltage value.

20. The voltage generation circuit according to claim 17, wherein
each of the first booster circuit, the second booster circuits, and the third booster circuits has a charge pump including a plurality of diodes connected in series and a plurality of capacitors, first ends of the capacitors being connected to respective stages of the diodes and second ends of the capacitors being supplied with clock signals, and
the number of the stages of the charge pump in the first booster circuit is greater than the number of the stages of the charge pump in each one of the second booster circuits and than the number of the stages of the charge pump in each one of the third booster circuits.
